(19) United States
(12) Patent Application Publication
(10) Pub. No.: US 2023/0363393 A1
(43) Pub. Date: Nov. 16, 2023

(54) OXIDIZED NITRIDE AND NITRIDED SILICA CERAMIC FOR SAFER AND LONG-TERM INACTIVATION OF VIRUS

(71) Applicant: VIATON AB, Knivsta (SE)

(72) Inventors: Håkan ENGQVIST, Uppsala (SE); Wei XIA, Uppsala (SE); Ioannis KATSAROS, Uppsala (SE)

(73) Assignee: VIATON AB, Knivsta (SE)

(21) Appl. No.: 18/026,408

(22) PCT Filed: Jul. 7, 2021
(86) PCT No.: PCT/SE2021/050688

§ 371 Date: Mar. 15, 2023

(30) Foreign Application Priority Data
Sep. 16, 2020 (SE) 2030288-1

(51) Int. Cl. A01N 59/00; A01P 1/00; C04B 35/626

(52) U.S. Cl. CPC A01N 59/00; A01P 1/00; C04B 35/6265; C04B 2235/3873; C04B 2235/5445

(57) ABSTRACT

The present invention is within in the field of ceramic material for biomedical applications. The present invention relates to a silicon oxynitride powder or an oxidized silicon nitride powder having the general chemical formula SiₓO_{y}N_{z}. The powder comprises 0.1-50 wt % oxygen, or 7-12 wt % oxygen, or 10-12 wt % oxygen. The silicon oxynitride powder according to the invention is suitable for anti-pathogen applications.

### TECHNICAL FIELD

The invention relates to a process for producing oxidized nitride and nitriding silica ceramics for anti-pathogen applications. In particular, the invention provides a process for providing a controlled oxygen content in nitride ceramics, such as silicon nitride and titanium nitride, and nitriding silica. The invention also comprises materials manufactured using the method and more specifically, the in relates to oxynitride ceramic and nitriding silica compositions.

### BACKGROUND OF THE INVENTION

Shielding society from viral infections has become a universal need due to the repeated appearance of global pandemics, of various severities, in the past 20 years alone. In 2009, during its first year of circulation, the H1N1 virus caused a pandemic that lead to the death of an estimated 151700-575400 people worldwide. Today, the spread of human SARS-CoV-2 is responsible for a global pandemic that has caused around several hundreds of thousands of deaths worldwide. Surfaces, including our hands, play an important part in the spread of viruses. Viral transmissions can occur via close human-to-human contact or via contacting a contaminated surface. Materials that possess antipathogenic properties can play a vital role in the prevention of the spread of viruses. Such materials can be used in medical devices and equipment as well as in the manufacturing, modification, or disinfection of surfaces in an effort to inactivate viruses or prevent their attachment and proliferation on them. Additionally, such materials can be used in solution as disinfecting agents for daily use.

Similarly, bacterial infections have been a cause for concern mainly in the medical industry. With implants, orthopaedic or dental, being used increasingly to improve the quality of lives of millions of patients worldwide the impact of potential bacterial infections and post-surgery complications to society is vast. Implants created, partially or entirely, using antipathogenic materials can be a solution to minimise the risk of bacterial infection and ensuring safer procedures for the patients.

Due to the need for reliable measures of protection from viral and bacterial infections, materials have been increasingly used in an effort to inactivate or reduce the spread of pathogens. Metals are typical materials which have been used for antivirus application. The use of metal nanomaterials to form self-disinfecting surfaces have gained traction in recent years, as viruses can persist on contaminated surfaces for prolonged periods. However, metal particles are toxic in vivo, causing severe side effects. National Institute of Health (NIH) and US Food and Drug Administration (FDA)'s guidance on silver (Ag) particles and colloidal silver says that they can cause serious side effects. Gold (Au) and copper (Cu) nanoparticles and ions could still show cytotoxicity at viral inhibitory concentrations. Therefore, the use of these metal or metal nanoparticles should be very careful regarding, such as dose/composition and ion release/leakage. Some ceramics, such as silicon nitride, have been reported to have an effect on virus inactivation. Compared to metals, oxide and nitride ceramics are general more inert, therefore they are safer in this case. Silicon oxynitride (Si₂O₂N) is a non-toxic ceramic material used in a variety of applications due to its excellent behaviour in demanding environments. As a part of the material family of nitrides, it also has the potential to significantly and reliably reduce the activity of various pathogens.

Consequently, the societal need for pathways through which people will be protected from exposure to potentially dangerous pathogens is vast and may be met by the use of materials with a significant and lasting antiviral and/or antibacterial behaviour. Using such materials in various manners can prove to be a very important step towards minimising the negative effects of current and future health crises.

US 2020/0079651 A1 discloses compositions, devices, and methods for inactivating viruses, bacteria, and fungi. The compositions, methods, and devices includes coatings and slurries comprising silicon nitride powder.

EP 0227324 A2 discloses a method for making fusable, one component silicon nitride powder having a purity of equal to or greater than 99.98% and having a fine particle size, and a method for making a silicon oxynitride agent having a purity equal to or greater than 99.98%.

In the prior art there is a need for an antiphatogen material suitable for biomaterial applications, and for a method of making such a material.

### SUMMARY OF THE INVENTION

The object of the present invention is to provide an anti-pathogen material and a method of making such that overcomes the drawback of the prior art.

This is achieved by the powder as defined in claim 1, and the method as defined in claim 9.

In a first aspect of the invention there is a silicon oxynitride powder or an oxidized silicon nitride powder having the general chemical formula SiₓO_{y}N_{z}.

In one embodiment of the invention the powder comprises 0.1-50 wt % oxygen and 1-60 wt % nitrogen, or 12-17 wt % nitrogen and 38-42 wt % oxygen, or around 15 wt % nitrogen and around 38 wt % oxygen.

In one embodiment of the invention the powder comprises 0.1-50wt % oxygen, or 7-12 wt % oxygen, or 10-12 wt % oxygen.

In one embodiment of the invention the powder is X-ray amorphous. In one embodiment of the invention the powder is crystalline.

In one embodiment of the invention the powder comprises hydroxyl surface groups when in contact with water.

In one embodiment of the invention the grain size is <500 μm, or 0.1-2 μm, or 150-900 nm.

In a second aspect of the invention there is a method of forming a silicon oxynitride powder or an oxidized silicon nitride powder comprises 0.1-50 wt % oxygen and 1-60 wt % nitrogen, or 12-17 wt % nitrogen and 38-42 wt % oxygen, or around 15 wt % nitrogen and around 38 wt % oxygen. The method comprises heat treatment of silicon nitride powder at 900-1100° C. for 0.5-10 hours, or 4-7 hours and wherein the heat treatment is performed in air or oxygen atmosphere.

In one embodiment of the invention the heat treatment is performed for around 4 hours. In one embodiment of the invention the heat treatment is performed for around 7 hours.

In one embodiment of the invention the powder is placed in an air furnace at 20-25° c. and then heated to 900-1100° C. using a ramping time of 1-15° C./min, or 10-15° C./min.

In a third aspect of the invention there is an antipathogen product comprising silicon oxynitride powder comprising 10.1-50 wt % oxygen and 1-60 wt % nitrogen, or 12-17 wt % nitrogen and 38-42 wt % oxygen, or around 15 wt % nitrogen and around 38 wt % oxygen.

In one embodiment of the invention the antipathogen product comprises 0.25-100 wt %, or 0.25-40 wt %, or around 0.5 wt % silicon oxynitride or oxidized silicon nitride.

In one embodiment of the invention the silicon oxynitride or oxidized silicon nitride is deposited on the surface of the anti-pathogen product.

In one embodiment of the invention the anti-pathogen product is a solution and the silicon oxynitride is incorporated in the solution.

### BRIEF DESCRIPTION OF FIGURES

FIGS. 1 a) and b) are SEM images of one embodiment of the invention;

FIG. 2 is a graph according to one embodiment of the invention;

FIG. 3 is an illustration according to one example of the invention;

FIG. 4 is a graph according to one embodiment of the invention;

FIGS. 5 a) is a SEM image according to one embodiment of the invention, b) is a SEM image according to a comparative example, c) is an X-ray diffractogram according to one embodiment of the invention, and d) is an X-ray diffractogram according a comparative example;

FIG. 6 is a graph according to one embodiment of the invention; and

FIGS. 7 a) and b) are data according to one embodiment of the invention.

### DEFINITIONS

The term ‘grain size’ is used herein to refer to a ‘particle size’, such as a mean or median particle size as determined by for example scanning electron microscopy (SEM), particle size distribution measurements based on laser diffraction, etc.

‘Silicon oxynitride’ is a ceramic material with the general chemical formula SiₓO_{y}N_{z}, it can be crystalline or amorphous.

The terms ‘material’ and ‘powder’ are used interchangeably throughout the specification and refer to a solid material in the form of small particles, or powder.

The terms ‘weight percent’ and ‘wt %’ both refer herein to percent by weight, i.e. the weight fraction of a component in relation to the total weight of a composition including the component, expressed in percent.

The term ‘anti-pathogen’ incudes both anti-viral and anti-bacterial, i.e. something that suppresses or inhibits bacterial or virus reproduction and/or growth.

### DETAILED DESCRIPTION

Described herein is a surface, bulk, solution, slurry or lotion containing an oxidized silicon nitride, including silicon oxynitride, and nitrided silica powder to be in contact with surfaces, devices or humans in order to inactivate or prevent the adhesion of pathogens such as viruses and bacteria. The aforementioned solution should contain the silicon oxynitride powder in concentrations high enough to inactivate the pathogens. The powder in the device could be mixed with distilled water or other solvents like ethanol and/or hydrogen peroxide among others.

Also, described herein are devices comprising oxidized silicon nitride, silicon oxynitride and nitride silica. Such devices could be created using oxidized silicon nitride, silicon oxynitride or nitride silica powders as the main or part of a raw material that would be then thermally processed to the final device. In other cases, such a device could be created through a deposition method of the silicon oxynitride on other ceramics, metals polymers or fibres.

Also described herein is a method for inactivating pathogens by bringing them in contact with the above devices. The method could be applied for the disinfection of other surfaces and devices as well as that of human skin, due to the non-toxic nature of the material. Also described herein is a method of obtaining oxidized silicon nitride, silicon oxynitride and/or nitride silica powders from a starting powder, i.e. silicon nitride, silica. This method is a way to control the oxygen content of the powders. The created powders can be utilised as raw materials for the production of surfaces, fillers, solutions, other devices and apparatuses, for the deposition of a silicon oxynitride and nitride silica layer on existing devices or its incorporation in solutions, slurries or lotions.

Provided herein are devices, apparatuses or coatings that will utilise silicon oxynitride and/or nitrided silica powders to inactive pathogens such as viruses and bacteria. These apparatuses can be used in a variety of applications, spanning from the synthesis of bulk ceramics with antipathogenic behaviour and the lending of such properties to other materials through coatings and composites to disinfecting solutions, sprays or gels that could be used on surfaces and humans alike. These materials could be medical devices and equipment or everyday appliances and clothing.

In one embodiment, the silicon oxynitride powder could be dispersed into a liquid containing oil, lotion, gel, distilled water, ethanol or hydrogen peroxide or a mixture of the above in order to be brought in contact with surfaces or humans to inactivate pathogens. In such embodiments, silicon oxynitride could be added to the liquid(s) in a concentration ranging from 0.25-40% w/v enough to inactivate pathogens. Stabilizing agents could also be added to the mixture to create a device of a specific consistency. The grain size of the powder is below 500 micrometer.

In other embodiments, the oxynitride powder could be used as a raw material for the manufacturing of medical devices and equipment. These devices could be produced by a thermal process or the combination of such. Such embodiments can be fully dense, porous or a combination thereof. In these devices, silicon oxynitride could be used as the sole raw material or partly, in combination with other ceramics, polymers or metals. Examples of such embodiments could be orthopaedic and dental implants with antipathogenic behaviour, among others. The grain size of the starting powder is below 500 micrometer.

In another embodiment, the silicon oxynitride powders can be deposited or used as a coating material on other devices or parts of them. In such embodiments, silicon oxynitride would be on the outer surface of these devices, exposed to pathogens that could come in contact with it and be inactivated. The substrate for these depositions or coatings could be ceramic, polymer, metal or fibre.

In yet another embodiment, the silicon oxynitride coating on devices can be formed via nitriding a SiO₂ or Si surface coating.

Also provided herein is a method through which the inactivation of various pathogens such as viruses and bacteria could be achieved. In this method, silicon oxynitride is brought in contact with the pathogen leading to its inactivation. In such a method, silicon oxynitride could come in contact with the pathogen in powder form, in a solution, as a coating or a dense material.

In one embodiment, the devices or apparatuses provided herein could be utilised in order to inactivate the human adenovirus (HAdV).

Silicon oxynitride has surface chemistry such that when in contact with water, ammonia and ammonium ions could be eluted and/or formed in the material or particle surface. Such compounds have been proven to play a crucial role in the inactivation of pathogens such as bacteria and viruses. The unique coexistence of oxides and nitrides in silicon oxynitride makes it advantageous for its antipathogenic properties as the oxidation could enhance the hydrolysis and reactive nitrogen species liberation.

In a first aspect of the invention there is a silicon oxynitride powder or an oxidized silicon nitride powder having the general chemical formula SiₓO_{y}N_{z}.

In one embodiment of the invention the powder comprises 0.1-50 at % oxygen and 1-60 at % nitrogen, or 12-17 at % nitrogen and 38-42 at % oxygen, or around 15 at % nitrogen and around 38 at % oxygen. In one embodiment of the invention the powder comprises 0.1-50 wt % oxygen and 1-60 wt % nitrogen, or 12-17 wt % nitrogen and 38-42 wt % oxygen, or around 15 wt % nitrogen and around 38 wt % oxygen. The composition ratios could be in wt % and/or at %. Such composition could for example be determined by X-ray photoelectron spectroscopy (XPS), or any other suitable characterization technique. XPS is a surface sensitive technique a generally shows the surface composition of the material, including a few atomic layers beneath the surface.

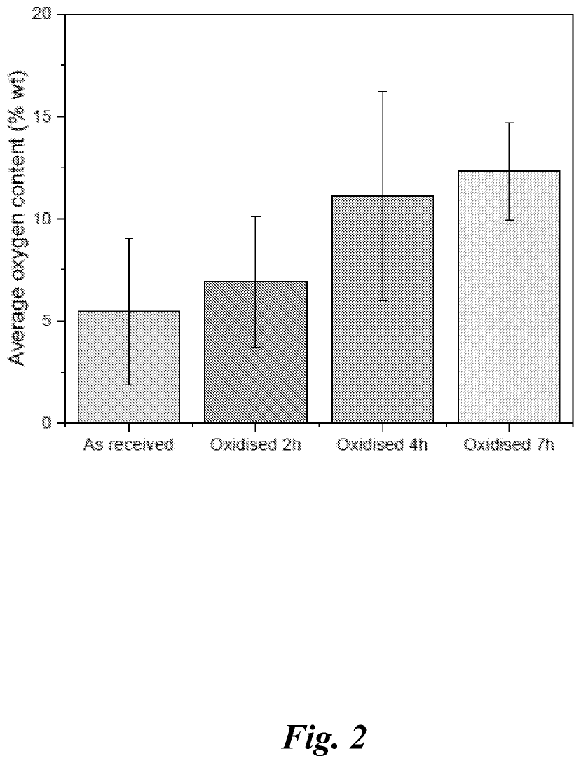

In one embodiment of the invention the powder comprises 0.1-50 wt % oxygen, or 7-12 wt % oxygen, or 10-12 wt % oxygen. The oxygen content is to be considered as general oxygen content and can be measured by for example Energy dispersive spectroscopy (EDS), or any other suitable characterization technique. An example of the general oxygen content of a material according to the invention can be seen in FIG. 2. EDS examines the (bulk) composition of a material.

Such a material may be crystalline or X-ray amorphous, or a mixture of crystalline and X-ray amorphous.

A silicon oxynitride material, or a nitride silicon oxide material generally comprises both silanol, or other -OH groups, as well as reactive nitrogen species.

When in contact with water, or moisture a material according to the invention may form hydroxyl (—OH) surface groups. The hydroxyl groups may be in the form of silanol groups (Si—OH) located on the surface of the material. A material or powder according to the invention may be hydrophilic due to the presence silanol or hydroxyl surface groups. A hydrophilic material may be advantageous in terms of anti-pathogen or anti-viral properties.

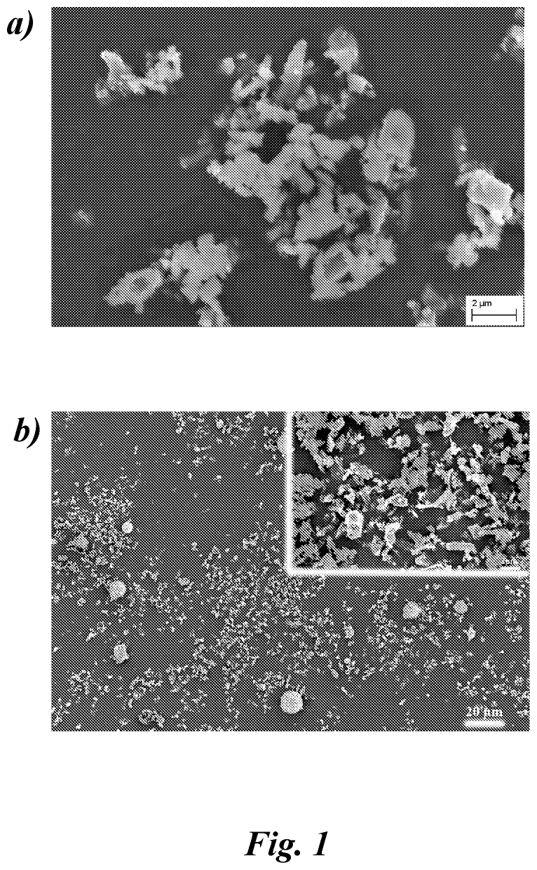

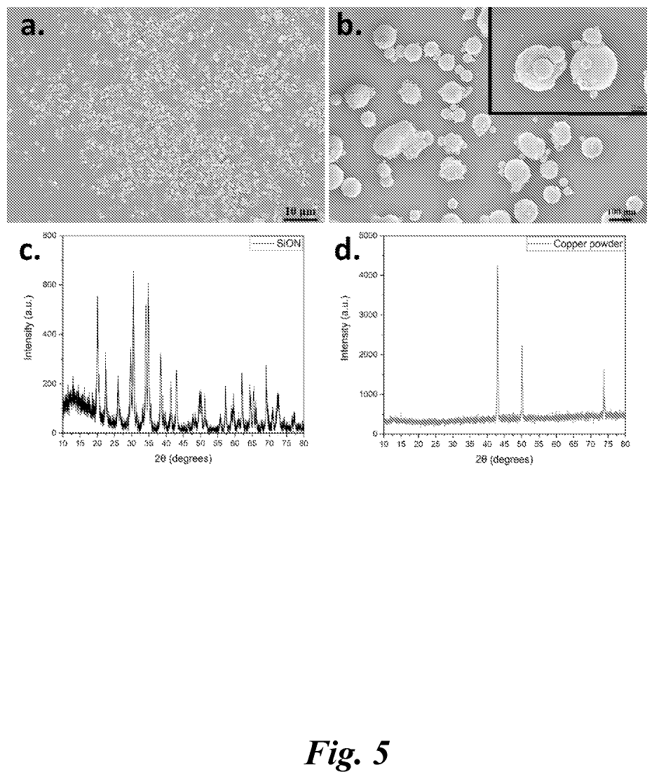

Examples of SEM images of a material according to the invention are shown in FIGS. 1a and b, as well as in FIG. 5a. As can be seen the silicon oxynitride materials are in the form of small particles, <500 μm, or 0.1-2 μm, or 150-900 nm, that form soft agglomerates.

A material according to the invention such as an oxidized silicon nitride powder may form and possible release reactive nitrogen species when in contact with water and/or humidity. This can be seen for example by an ammonia release test.

In one aspect of the invention there is an anti-pathogen product comprising silicon oxynitride powder comprising 10.1-50 wt % oxygen and 1-60 wt % nitrogen, or 12-17 wt % nitrogen and 38-42 wt % oxygen, or around 15 wt % nitrogen and around 38 wt % oxygen. The anti-pathogen product may comprise 0.25-100 wt %, or 0.25-40 wt %, or around 0.5 wt % silicon oxynitride or oxidized silicon nitride.

Silicon oxynitride or oxidized silicon nitride according to the invention may be deposited on the surface of a product to form an anti-pathogen product. In other embodiments of the anti-pathogen product, it may be in the form of a solution wherein silicon oxynitride or oxidized silicon nitride according to the invention is incorporated in the solution, for example in the form of a slurry, cream, paste, etc.

It is an advantage with the invention that a silicon oxynitride or oxidized silicon nitride may inactivate viruses and bacteria while being non-cytotoxic or non-harmful against human cells.

In one aspect of the invention there is a method of forming a silicon oxynitride powder or an oxidized silicon nitride powder comprising 0.1-50 wt % oxygen and 1-60 wt % nitrogen, or 12-17 wt % nitrogen and 38-42 wt % oxygen, or around 15 wt % nitrogen and around 38 wt % oxygen. The method comprises heat treatment of silicon nitride powder at 900-1100° C. for 0.5-10 hours, or 4-7 hours and wherein the heat treatment is performed in air or oxygen atmosphere. In one embodiment of the method the heat treatment is performed for around 4 hours. In one embodiment of the method the heat treatment is performed for around 7 hours.

Increased time for the heat treatment may lead to formation of a higher average oxygen content, as can be seen in FIG. 2. FIG. 2 shows the average oxygen content in wt % for different time periods of heat treatment. The optimal heat treatment may depend on factors such as particle size, size of furnace, amount of powder, etc. A skilled person can determine the appropriate time period for heat treatment depending on such factors.

In one embodiment of the invention the powder is placed in an air furnace at 20-25° c. and then heated to 900-1100° C. using a ramping time of 1-15° C./min, or 10-15° C./min.

Heat-treating a silicon nitride powder in an oxygen atmosphere may lead to oxidation of the powder and formation of silanol (Si—OH) groups on the surface of the powder. Silanol groups may increase the hydrophilicity of the material which is advantageous in terms of anti-pathogen properties.

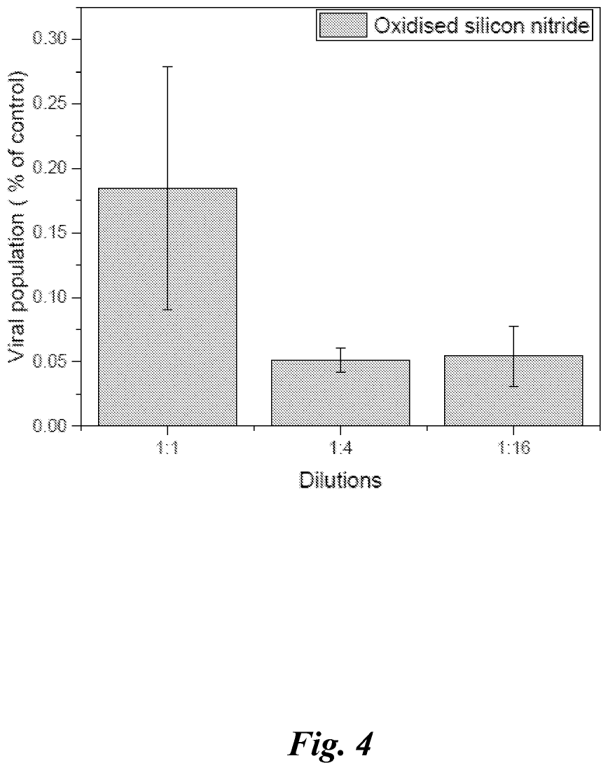

FIG. 4 shows the decrease in viral population after being treated with a powder according to the invention with different dilutions (i.e. different concentrations of powder). As can be seen in the Figure a concentration of 0.25 wt % powder in a solution, or a 1:4 dilutions lead to a large decrease in viral population.

All aspects, variants and embodiments described herein can be combined unless explicitly stated otherwise.

### EXAMPLES

### Example 1

### Controlled Oxidization of Silicon Nitride

To control the amount of oxide formation, an as received silicon nitride powder was oxidised using heat treatments of different duration and the oxygen content was correlated with the dwelling time. A homogenous thin layer of powder was deposited on an alumina surface that was placed in an air furnace. The powders were heated from room temperature to 1070° C. at a heating rate of 12° C./minute. Three different dwelling times at 1070° C. were chosen: 2, 4 and 7 hours. The powders were then furnace cooled to room temperature and the oxygen content of different particles was examined using Electron Dispersive Spectroscopy (EDS). The effect of the dwelling time during the oxidation can be seen in FIG. 2, that shows the average oxygen content for the powders heat treated for different time periods. FIG. 1 a and b shows SEM images of the formed powder.

### Example 2

### Nitriding Silica

To produce nitrated silica powders a thin layer of silica powder was homogenously spread on an alumina surface. After that the powder was thermally annealed in temperatures between 800-1200° C. in a nitriding atmosphere. Some examples of such atmospheres are NO, N₂O and NH₃.

### Example 3

### Inactivation of Human Adenovirus by Silicon Oxynitride Powder

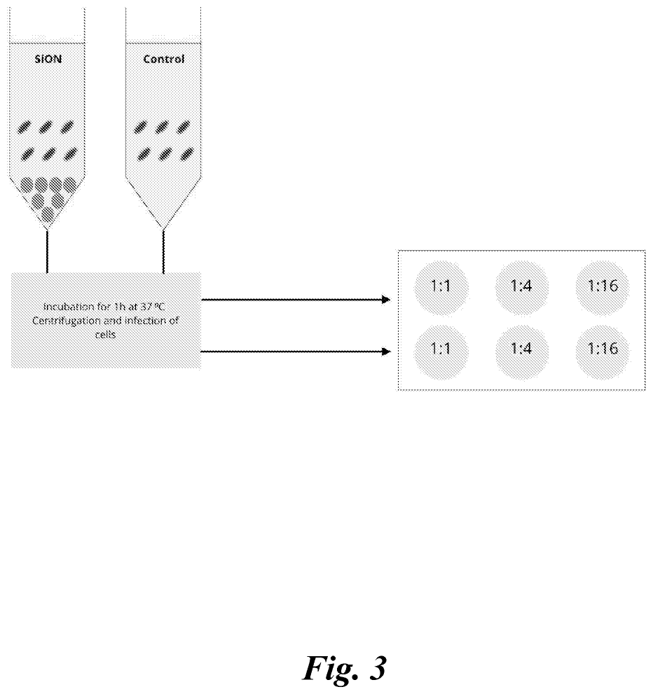

To show the effect of the silicon oxynitride powders on the activity of the adenovirus, the virus was exposed to slurries of silicon oxynitride, at a concentration of 0.5% w/v. 5 mg of powder was added to 1 mL of a solution containing the virus, and the mixture was incubated at 37° C. for 1 h. Similarly, 1 mL of the viral solution was incubated for 1 h as a control. Both mixtures/solutions were lightly shaken during incubation. After the incubation time had elapsed, both mixtures were centrifuged at 12000 rpm for 5 minutes in order to extract the viral supernatant. That was then used to infect epithelial cells of the A549 line that were left to incubate for 24 h. After incubation, a Dual-Luciferase Reporter (DLR) assay was used to quantify the viral population. The method is schematically described in FIG. 3. The estimated population of the virus exposed to the silicon oxynitride powder is shown as a percentage of that of the control in FIG. 4.

### Example 4

### Preparation of Silicon Oxynitride

To prepare the oxynitride powder, silicon nitride powder was oxidized in air for 7 hours at 1070° C. This process has been shown to produce highly oxidized silicon nitride surfaces that retain nitrogen at an atomic ratio lower than 10%. The morphology and crystal structure of the two powders were analysed through Scanning Electron Microscopy (SEM) and powder X-Ray diffraction (XRD). To showcase the hydrophilicity of silicon oxynitride, the sessile drop method was used on bulk silicon nitride samples that were oxidised using the same process to evaluate hydrophilicity. Finally, to ensure that nitrogen was still present on the powders, an ammonia release kit was utilised.

Antiviral testing: For the evaluation of the antiviral properties of silicon oxynitride, solutions of SARS-CoV-2 (PM5, Swedish isolate) at a titer of 10⁴ PFU/ml were prepared. The viral solutions were brought in contact with silicon oxynitride powders and copper powders at a final concentration of 10% w/v. Copper was used as a positive control due to its known antiviral activity while viral solutions that were not brought in contact with any material that were used as negative controls. The samples were brought in contact with the virus for 1 minute, 10 minutes and 1 hour, after which the vials were centrifuged at 4000 rpm for 10 minutes so the powders could be separated from the supernatant. Both powders and supernatants were then subjected to RNA extraction using the Direct zol™ 96-plate extraction kit followed by a SARS-CoV-2 E gene RT-qPCR. The infectivity of the virus in the supernatants was then evaluated through a plaque assay on monolayers of Vero E6 cells. The above procedure was followed at 25 and 37° C.

### Results Example 4

FIG. 5a shows a SEM image of the silicon oxynitride powder and FIG. 5b shows a SEM image of the copper powder. Examining the morphology through SEM, it was clearly visible that there were differences between the silicon oxynitride and the copper powders. While they both exhibited soft agglomerations, the particles of the silicon oxynitride powder were significantly smaller, explaining the higher apparent density of the material. XRD confirmed that the silicon oxynitride powder was crystalline Si₂O₂N (see FIG. 5c) and that the copper powder was crystalline copper (Cu) (see FIG. 5d). It is also possible to see from the XRD recordings that the silicon oxynitride powder comprises smaller particles than the copper powder due to the less distinct peaks in the diffractogram (FIG. 5c).

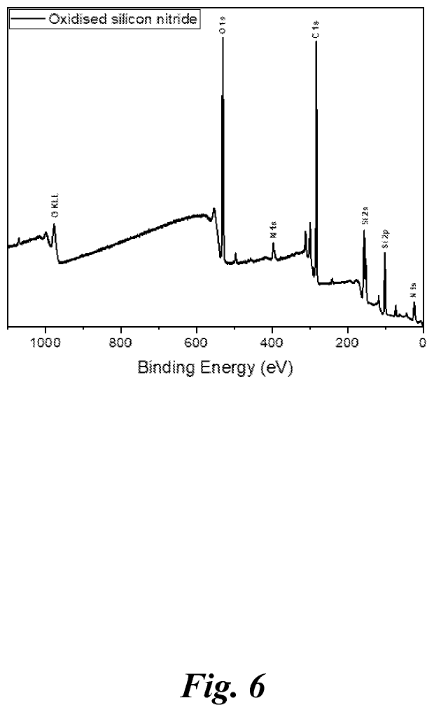

X-ray photoelectron spectroscopy (XPS) analysis of the formed silicon oxynitride powder is shown in FIG. 6. As can be seen the powder is composed of oxygen, carbon, nitrogen and silicon. Table 1 below shows the composition in atomic% from the XPS analysis.

TABLE 1
Composition (at %) of silicon oxynitride
powder from XPS analysis

| Si | N | O | C | Other (Al and Na) |
|---|---|---|---|---|
| 15.16 | 2.09 | 38.25 | 40 | 3.71 |

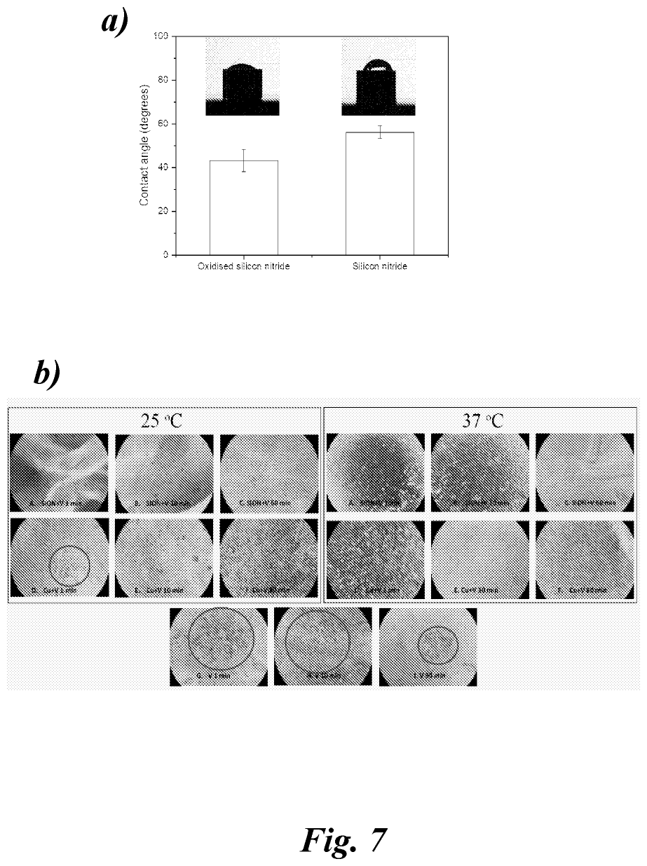

FIG. 7a shows the results from the wetting angle measurements (left-hand side oxidized silicon nitride, right hand side silicon nitride). The wetting angle measurements confirmed that oxidized silicon nitride materials were highly hydrophilic. The oxidation of the powder led to the formation of silanol groups (Si—OH) on the surface of the material as shown by the increased hydrophilicity of the material.

The ammonia release assay indicated that while the powder was highly oxidized the remaining nitrogen in the material was still forming and releasing reactive nitrogen species.

FIG. 7b shows the results of the plaque forming unit assay. The cytopathic (or cytopathogenic, i.e. structural changes in the cell caused by virus) effect on the cells as a result of infection is highlighted by the drawn circles, in 25° C.: D (Cu V 1 min), G (V 1 min), H (V 10 min), I (V, 60 min). As a reference, cells infected by viral solutions untreated by any substance are presented in G, H, I on the last line in FIG. 7b.

The plaque forming unit assay was employed to assess the infectivity of the virus after being brought in contact with the test material and control. At 25° C., silicon oxynitride rendered the virus not infective after all contact times (see FIG. 7b: A, B, C 25° C.). The results indicated that the material had a superior antiviral behavior to copper as it inactivated the virus after as little as one minute of contact, while copper did not (see FIG. 7b: D, E, F 25° C.). Furthermore, cells treated with the supernatant from silicon oxynitride exhibited a normal morphology reconfirming the biocompatible nature of the material. At 37° C. both testing materials and positive controls (copper) were effective in inactivating the virus in all contact times, indicating that the virus is less stable at higher temperatures (see FIG. 7b: A-F 37° C.).

The viral genomic RNA from both powders and supernatants was examined by using Reverse transcription quantity PCR (RT-qPCR). A threshold CT (number of cycles needed in the PCR for the virus to be detected) value of 35 was chosen. Based on this criterion, it was found that all CT values from all virus control groups were below. All silicon oxynitride test groups had CT values higher than 35, except for the group treated only for one minute at 37° C. The supernatants from the Cu test groups had lower CT values compared to the silicon oxynitride groups, indicating a higher antiviral activity of silicon oxynitride as compared to Cu.

1. A silicon oxynitride powder or an oxidized silicon nitride powder having a general chemical formula SiₓO_{y}N_{z}, and where the powder has a grain size of 0.1-2 μm.

2. The powder according to claim 1, wherein the powder comprises 0.1-50 wt % oxygen and 1-60 wt % nitrogen.

3. The powder according to claim 1, wherein the powder comprises 0.1-50wt % oxygen.

4. The powder according to claim 1, wherein the powder is X-ray amorphous.

5. The powder according to claim 1, wherein the powder is crystalline.

6. The powder according to claim 1, wherein the powder comprises hydroxyl surface groups when in contact with water.

7. (canceled)

8. The powder according to claim 1, wherein the grain size is 150-900 nm.

9. A method of forming a silicon oxynitride powder or an oxidized silicon nitride powder comprising 0.1-50wt % oxygen, the method comprising:
heat treating silicon nitride powder at 900-1100° C. for 0.5-10 hours,
wherein the heat treating is performed in air or oxygen atmosphere.

10. The method according to claim 9, wherein the heat treating is performed for around 4 hours.

11. The method according to claim 9, wherein the powder is placed in an air furnace at 20-25° c. and then heated to 900-1100° C. using a ramping time of 1-15° C./min.

12. The method according to claim 9, wherein the powder has a grain size of <500 μm.

13. An antipathogenic product, comprising a silicon oxynitride powder having a general chemical formula SiₓO_{y}N and comprising 1-50 wt % oxygen and 1-60 wt % nitride, wherein a grain size of the powder is 0.1-2 μm.

14. The antipathogenic product according to claim 13, wherein the antipathogenic product comprises 0.25-100 wt % of the silicon oxynitride powder.

15. The antipathogenic product according to claim 13, wherein silicon oxynitride or oxidized silicon nitride is deposited on a surface of the product.

16. The antipathogenic product according to claim 13, wherein the antipathogenic product is a solution and silicon oxynitride is incorporated in the solution.

17. The powder according to claim 2, wherein the powder comprises 12-17 wt % nitrogen and 38-42 wt % oxygen.

18. The powder according to claim 3, wherein the powder comprises 7-12 wt % oxygen.

19. The method according to claim 12, wherein the grain size is 0.1-2 μm.

20. The antipathogenic product according to claim 13, wherein the antipathogenic product comprises 0.25-40 wt % of the silicon oxynitride powder.
